(19) United States
(12) Patent Application Publication
(10) Pub. No.: US 2001/0029549 A1
(43) Pub. Date: Oct. 11, 2001

(54) Computer farm simulating a local area network with monitoring of simulation

(76) Inventor: Hugo Delchini, Paris (FR)

Correspondence Address: Robert W. Bergstrom, Summit Law Group PLLC, Suite 300, 1505 Westlake Ave. N., Seattle, WA, 98109, US

(21) Appl. No.: 09/728,248

(22) Filed: Nov. 30, 2000

(30) Foreign Application Priority Data
Apr. 5, 2000 (FR) FR0004364

(51) Int. Cl. G06F 15/16

(52) U.S. Cl. 709/251

(57) ABSTRACT

The invention relates to a computer farm, comprising a bus (7) on which is simulated a local area network between several processor cards (3a-3h) mounted on the bus. Each card comprises a test function (11) which implements, upon execution thereof, at least part of the functionalities required for simulating the local area network on the card and a module for executing the test function, whilst the farm comprises a test means which periodically executes the same calculation as the same test function and compares its result with the result provided by the card.

The present invention relates to a computer farm simulating a local area network with monitoring of simulation.

More precisely, the invention concerns a computer farm comprising a bus on which is simulated a local area network between several processor cards mounted on the bus.

Computer farms of the type comprising a bus on which a local area network is simulated are already known.

In these farms, the data exchanges between computers are carried out via the bus, in a data packet format complying with the specifications of the simulated local area network.

Therefore, in each computer, the operating system receives and dispatches data packets exactly in the same way as if it were linked to the other computers by a genuine local area network.

This type of simulation is particularly beneficial, given that the transferring of the data by the bus makes it possible to achieve transfer rates quite out of all proportion to those of local area networks, and to do so with much greater reliability, since the structure of the bus precludes data collisions.

The drawback of such simulated networks is that they can experience malfunctions whose origin is not always easy to diagnose.

Specifically, if an item of system software or application software is executing abnormally on one of the computers, the situation is the same as on a genuine local area network.

On the other hand, where a malfunctioning of the simulation of the local area network is involved, the situation is peculiar to the simulated networks and the items of software other than those concerned with the simulation ought not to be called into question.

The difficulty is that the mere observing of a fault on one computer of the farm does not make it possible to distinguish between these two categories of malfunction.

The present invention aims to propose a solution for diagnosing the malfunctions of the simulation of the network.

The subject of the present invention is a computer farm, comprising a bus on which is simulated a local area network between several processor cards mounted on the bus, wherein:

each card comprises, on the one hand, stored in a nonvolatile memory, a test function which implements, upon execution thereof, at least part of the functionalities required for simulating the local area network on the card and performs a given calculation so as to provide a result, and, on the other hand, a module for executing the test function, which continuously scans a predefined parameter memory area of the card and, when it detects a value written to the parameter memory area, triggers execution of the test function with said value as parameter,

the farm comprises a test means which periodically executes the following operations:

writing, to the parameter memory area of each of the processor cards, of a value specific to each processor card and to each write, by a bus write cycle which is independent of the operation of the simulated network,

execution of the same calculation as the test function, taking said value as parameter, so as to obtain a reference result,

retrieval of the result of the calculation performed by the test function of the processor card,

comparison with the reference result,

should there be a difference between the two results, triggering of a processor card retrofit action.

The benefit of the farm according to the invention is that the functionalities required for implementing the simulation are regularly tested on each processor card of the farm, by a test means which communicates with each card via the bus, and independently of the state of the simulations of the network on each card.

In this way, if the simulation of the network on one of the cards is not operating correctly, it will nevertheless be possible to run the test and, perhaps, it will be possible to undertake a more complete diagnosis of the card.

In a particular embodiment of the invention, the retrofitting of the card consists in its reinitialization.

In a particular embodiment of the invention, the value written to the parameter memory area depends in particular on the location of the card on the bus.

`This value can also be determined as a function of other criteria chosen in such a way that a single value is provided to each card and to each test during the calculation.

The present invention applies in particular to network simulations on PCI or CompactPCI type buses for an Ethernet type network.

With the aim of providing a clearer understanding of the invention, an embodiment thereof given by way of nonlimiting example will now be described with reference to the appended drawing, in which:

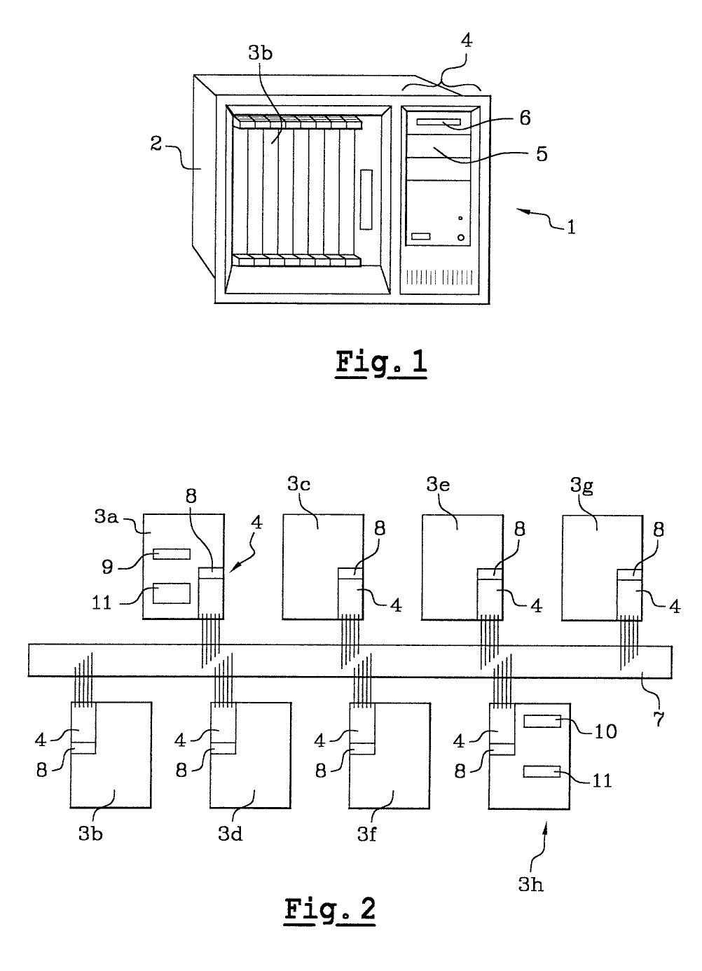

FIG. 1 is a three-quarter perspective front view of a computer farm according to the invention,

FIG. 2 is a diagrammatic view of a bus and of an assembly of processor cards mounted on this bus,

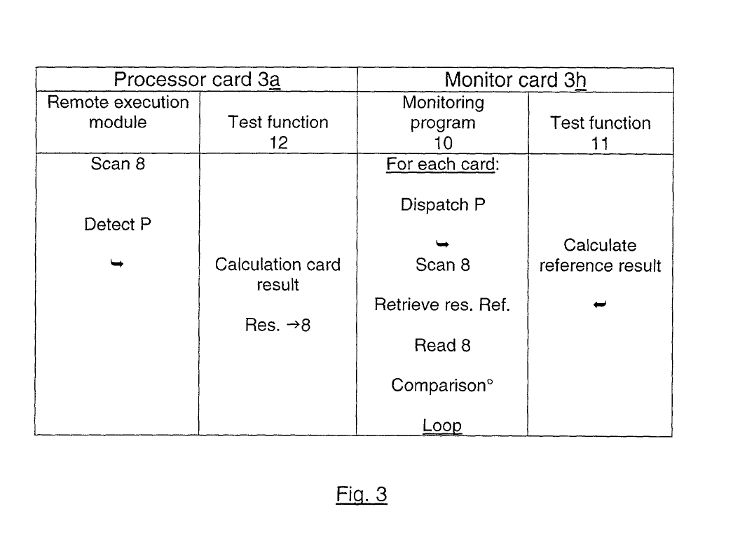

FIG. 3 is a chart illustrating the operations executed when testing one of the processor cards.

### The farm 1 represented in the drawing comprises a box 2 which accommodates a bus (not visible in this figure) on which are mounted eight processor cards 3a-3h.

The farm comprises a compartment 4 containing a supply assembly and mass memories consisting in particular of a hard disk 5, as well as a CD ROM drive 6.

The bus 7 is diagrammatically represented in FIG. 2, in which it may be seen that the processor cards 3a to 3h communicate with the bus by way of bridges 4, the data exchanges between the processor cards 3a- 3h being performed by read and write cycles on the bus 7.

Each bridge 4 contains registers, just one of which is represented here and will be referred to as the parameter register 8 in the subsequent description.

In the example described, the card 3h plays the role of monitor card. It monitors the state of the other cards.

For the clarity of the drawing, only the details of the card 3a and of the monitor card 3h will be described. The other cards 3b to 3g are identical to the card 3a, at least as regards the characteristics which will be described. The cards 3a to 3g may nevertheless be distinguished through other characteristics unconnected with the present invention.

The card 3a includes a nonvolatile memory 9, for example a read only memory (ROM), containing a series of preprogrammed functions and a remote execution module.

The preprogrammed functions are basic functions whose execution serves for the administration and the testing of the operation of the card. One of these functions is a test function for the card, as will be described.

The remote execution module has the role of triggering the execution of one of the basic functions, upon an instruction given by the monitor card 3h.

This instruction is given by the monitoring program 10, which executes in a loop on the monitor card.

With reference to FIG. 3, the manner in which the monitor card 3h tests the simulation of the network on the other cards 3a to 3g will now be described.

The monitoring program 10 of the monitor card 3h dispatches periodically, for example every second, a function parameter P specific to each card 3a to 3g.

This parameter P takes account of the location index number of the card tested on the bus, of the index number of the test performed for the set of cards and of a random number provided by the monitor card, so that the parameter in question is unique not only among the parameters dispatched during the same test cycle to the other cards but also among all the parameters already provided to the cards during previous tests.

The dispatching of the parameter is performed in master/slave mode, by direct writing via the bus of its value to the parameter register 8 of the card under test.

The monitor card 3h contains a test function 11.

The monitoring program triggers the execution of this test function 11 on the monitor card with the same parameter and retrieves the result provided by this test function. This result will be referred to hereinafter as the reference result.

On the processor card 3a, the remote execution module also executes in a closed loop, while continuously scanning the parameter register 8.

When it detects the value written by the monitoring program, the remote execution module triggers execution of a test function 12 identical to that contained by the monitor card 3h, with the value P of the parameter register 8 as parameter of this function.

The test function is executed and performs a calculation on the basis of the value provided as parameter, then returns a result which is written to the same parameter register 8.

The monitoring program reads the result written to the parameter register 8 together with the reference result and:

either notes the identity of the two results, in which case the card is regarded as correctly simulating the network,

or notes a difference between the two results, in which case the card is regarded as not operating normally.

In the second case, the card is reinitialized and reinstalled in the farm.

In the first case, no action is undertaken, the monitoring of the card is maintained by executing the same test cycle at the next period, for example one second later.

It is understood that the network simulation monitoring according to the invention provides a reliable diagnostic since the data packets of network type which are exchanged between the cards within the context of the network simulation adopt exactly the same method of dispatch, by direct writing during bus write cycles, as the parameter which is provided to the test function.

If the passing of the parameter and the retrieval of the result are performed without error, one may therefore regard the data packet transfers as being reliable without making too great an approximation.

The difference in the processing of the data packets by the simulation software lies in the fact that these data packets are transmitted to the higher layer of the network in a format which complies with the protocol of the simulated network, so that the network simulation is entirely transparent to the operating systems executing on the cards, whereas the test parameters remain within the simulation layer and are never transmitted to the operating system of the card.

The above embodiment is merely one example provided for a clear understanding of the invention, which is in no way limited to the characteristics described with reference to this example.

1. A computer farm, comprising a bus (7) on which is simulated a local area network between several processor cards (3a-3h) mounted on the bus, wherein:
each card comprises, on the one hand, stored in a nonvolatile memory (9), a test function (11) which implements, upon execution thereof, at least part of the functionalities required for simulating the local area network on the card and performs a given calculation so as to provide a result, and, on the other hand, a module for executing the test function, which continuously scans a predefined parameter memory area (8) of the card and, when it detects a value written to the parameter memory area, triggers execution of the test function with said value as parameter,
the farm comprises a test means which periodically executes the following operations:
writing, to the parameter memory area (8) of each of the processor cards, of a value (P) specific to each processor card and to each write, by a bus write cycle which is independent of the operation of the simulated network,
execution of the same calculation as the test function, taking said value as parameter, so as to obtain a reference result,
retrieval of the result of the calculation performed by the test function of the processor card,
comparison with the reference result,
should there be a difference between the two results, triggering of a processor card retrofit action.

2. The computer farm as claimed in claim 1, wherein the value (P) written to the parameter memory area (8) depends in particular on the location of the card on the bus.

3. The computer farm as claimed in either one of claims 1 and 2, wherein the retrofitting of the card consists in its reinitialization.

4. The computer farm as claimed in any one of claims 1 to 3, wherein the bus is of PCI or CompactPCI type.

5. The computer farm as claimed in any one of claims 1 to 4, wherein the local area network is an Ethernet network.
